(19) United States
(12) Patent Application Publication
(10) Pub. No.: US 2013/0083085 A1
(43) Pub. Date: Apr. 4, 2013

(54) ELECTRONIC APPARATUS AND ITS CONTROL METHOD

(71) Applicant: Tatsuo Yamaguchi, Kunitachi-shi (JP)

(72) Inventor: Tatsuo Yamaguchi, Kunitachi-shi (JP)

(73) Assignee: KABUSHIKI KAISHA TOSHIBA, Tokyo (JP)

(21) Appl. No.: 13/524,393

(22) Filed: Jun. 15, 2012

(30) Foreign Application Priority Data
Sep. 29, 2011 (JP) 2011-215709

(51) Int. Cl. G06F 3/038; G09G 5/10

(52) U.S. Cl. 345/690; 345/204

(57) ABSTRACT

One embodiment provides an electronic apparatus, including: a connection module configured to be detachably connected with an external device; a display module configured to display an image; and a display controller configured to control display of the display unit so that a larger image is displayed when the connection module is connected to the external device than when the connection module is not connected to the external device.

### CROSS-REFERENCE TO RELATED APPLICATION(S)

This application claims priority from Japanese Patent Application No. 2011-215709 filed on Sep. 29, 2011, the entire contents of which are incorporated herein by reference.

### FIELD

Embodiments described herein relate generally to an electronic apparatus and its control method.

### BACKGROUND

In recent years, rectangular, flat electronic apparatus classified as a slate type have come to be marketed. Furthermore, docking stations (cradles) for charging and extending functions of slate-type electronic apparatus have been developed.

It is done conventionally to make different operation settings in an electronic apparatus when it is connected to a docking station and when it is not. For example, a driver may control an audio controller according to docking station connection/removal information.

Among docking stations for slate-type electronic apparatus are ones which are configured so as to hold an electronic apparatus such that the electronic apparatus is erected and its display is directed in the horizontal direction. With such a docking station, a user can view a video etc. displayed on the display of an electronic apparatus that is mounted on the docking station. In the use form in which the electronic apparatus is mounted on the docking station, the distance between the user and the electronic apparatus is longer than in the ordinary use form in which the user uses the electronic apparatus holding it with his or her hand. Therefore, in the use form in which the electronic apparatus is mounted on the docking station, an image size and a sound volume are small to possibly cause viewing problems as long as they remain the same as in the ordinary use form.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates use forms of an electronic apparatus according to an embodiment is used.

FIG. 2 illustrates a system configuration of the electronic apparatus and a docking station according to the embodiment.

FIG. 3 illustrates a configuration relating to a first video palyback control performed in the electronic apparatus.

FIG. 4 illustrates a process for the first video palyback control.

FIG. 5 illustrates a configuration relating to a second video palyback control performed in the electronic apparatus.

FIG. 6 illustrates a process for the second video palyback control.

### DETAILED DESCRIPTION

One embodiment provides an electronic apparatus, including: a connection module configured to be detachably connected with an external device; a display module configured to display an image; and a display controller configured to control display of the display unit so that a larger image is displayed when the connection module is connected to the external device than when the connection module is not connected to the external device.

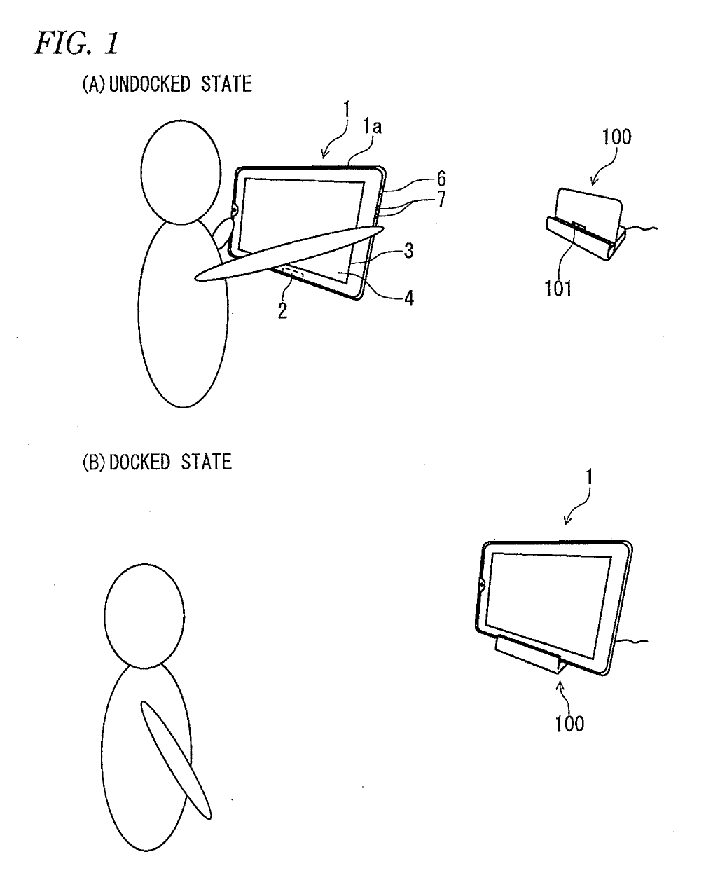

An embodiment will be hereinafter described with reference to the drawings. FIG. 1 illustrates use forms of an electronic apparatus 1 according to the embodiment is used. First, a description will be made of external structures of the electronic apparatus 1 and a docking station 100. As shown in FIG. 1, the electronic apparatus 1 has a rectangular, flat shape. The electronic apparatus 1 is a personal computer, a TV receiver, a smartphone, a cell phone, or the like of the slate type, the tablet type (a display device having a software keyboard function), or the like.

The electronic apparatus 1 has an LCD (liquid crystal display) 3 which is a display unit, a power switch 6, and LEDs (light-emitting diodes) 7 such that they are exposed in surfaces of a cabinet 1 a. A touch panel 4 is provided on the display surface of the LCD 3, and the LCD 3 and the touch panel 4 thus constitute a touch screen display.

The touch screen display detects a touch area (also called a touch position), touched by a pen or a finger, on the display screen. The user performs various manipulations by manipulating the touch panel 4 and the power switch 6.

The power switch 6 is provided on a side surface of the cabinet la so as to be exposed, and receives a manipulation input for powering on or off the electronic apparatus 1. The LEDs 7 are devices which emit light to notify the user of an operation state of the electronic apparatus 1. The LEDs 7 can indicate various operation states by combinations of light emission colors and lighting/flashing.

The electronic apparatus 1 has a connector 2 for connection to the docking station 100. The connector 2 is provided in an opening that is formed in a side surface of the cabinet 1a, so as to be exposed to the outside. For example, power, various data, a video signal, an audio signal, etc. are exchanged between the electronic apparatus 1 and the docking station 100 via (the terminals of) the connector 2.

Next, the docking station 100 according to the embodiment will be described. When connected to the electronic apparatus 1, the docking station 100 can add a connector to ones provided in the electronic apparatus 1 originally, extend a function provided in the electronic apparatus 1 originally, or add a function that is not provided in the electronic apparatus 1 originally. That is, the docking station 100 is an example function extending device for the electronic apparatus 1.

As shown in FIG. 1, the docking station 100 according to the embodiment supports, in an erected posture, the electronic apparatus 1 which is relatively thin and flat. That is, the docking station 100 is an example of a support device, a holding device, a support stage, a support member, a placement stage, and a holder for the electronic apparatus 1.

The docking station 100 has a first connector 101 (connection module, connection region) to be connected to the connector 2 (connection module, connection region) of the electronic apparatus 1. The docking station 100 supports the electronic apparatus 1 in a state that the first connector 101 and the connector 2 are connected to each other.

The back surface of the docking station 100 has a second connector (not shown in FIG. 1) for connection to a connector other than the connector 2 of the electronic apparatus 1 (i.e., a connector of another electronic apparatus). As such, the docking station 100 is also an example of an intermediary device to mediate between the electronic apparatus 1 and another electronic apparatus (not shown) or the like.

So that the docking station 100 can function as a function extending device, a connection device, an intermediary device, or the like as described above, a cabinet of the docking station 100 houses a circuit board (printed circuit board), electronic components, electric components, wiring, etc. as modules and components in addition to the first connector 101 and the second connector.

In the embodiment, two use forms, that is, an undocked state (A) (top part of FIG. 1) and a docked state (B) (bottom part of FIG. 1), are available. In the undocked state (A), the user uses the electronic apparatus 1 while holding it with his or her hand and performs a manipulation by touching the touch panel 4 with his or her finger or the like. In other words, the undocked state (A) is an ordinary use state of the electronic apparatus 1 having the touch screen.

In the docked state (B), the electronic apparatus 1 is mounted on the docking station 100 and erected vertically. Therefore, the user can view a video or the like displayed on the display at a position that is distant from the electronic apparatus 1. That is, in the docked state (B), no user manipulation is performed and the user mainly views a video being played back. The distance between the user and the electronic apparatus 1 is longer in the docked state (B) than in the undocked state (A). Therefore, in the docked state (B), an image size and a sound volume may be small to the user if they remain the same as in the undocked state (A). That is, since the user is distant from the electronic apparatus 1, a situation may occur that the user has difficulty viewing an image, characters of subtitles or the like are too small to read, or a sound is too small to hear. Measures employed in the embodiment to solve the above problems will be described below.

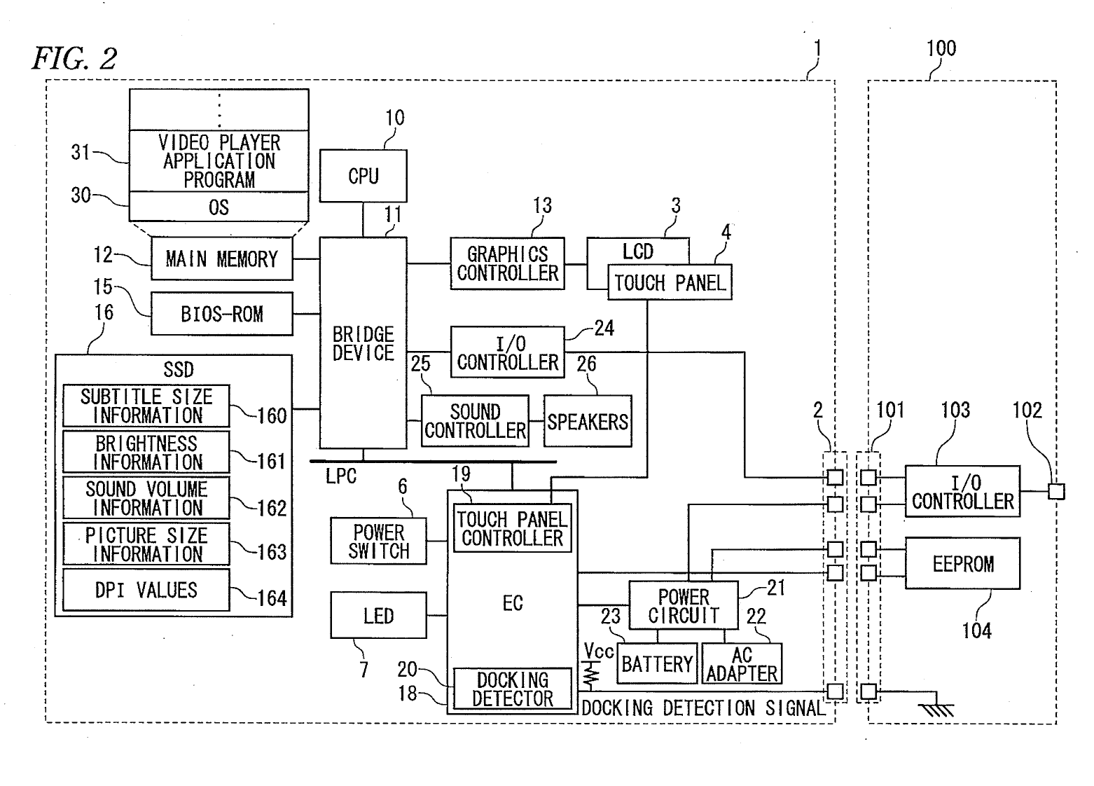

FIG. 2 illustrates a system configuration of the electronic apparatus 1 and the docking station 100 according to the embodiment. The electronic apparatus 1 has a CPU (central processing unit) 10, a bridge device 11, a main memory 12, a graphics controller 13, a BIOS-ROM (basic input/output system-read only memory) 15, an SSD (solid-state drive) 16, an embedded controller (EC) 18, a power circuit 21, a sound controller 25, speakers 26, etc.

The CPU 10 is a processor for controlling operations of the individual components of the electronic apparatus 1. The CPU 10 runs an operating system (OS) 30 and various utility/application programs that are read from the SSD 16 into the main memory 12. The CPU 10 also runs a BIOS that is stored in the BIOS-ROM 15. The BIOS is hardware control programs. In the embodiment, the CPU 10 also runs a video player application program 31.

The CPU 10 can switch the image size and the sound volume properly according to a use state of the electronic apparatus 1 by running the video player application program 31. The image may be a video (moving image) and may include characters. Example methods of image size switching are enlargement of part of an image, window size switching, and character size switching.

The bridge device 11 has a function of communicating with the graphics controller 13. The graphics controller 13 is a display controller for controlling the LCD 3 which is used as a display of the electronic apparatus 1.

The bridge device 11 incorporates a memory controller for controlling the main memory 12. Furthermore, the bridge device 11 communicates with individual devices on a PCI (peripheral component interconnect) bus and individual devices on an LPC (low pin count) bus.

The main memory 12 is a temporary storage area into which the OS 30 and the various application programs such as the video player application program 31 are read from the SSD 16 so as to be run by the CPU 10.

The graphics controller 13 performs display processing (graphics computation) for drawing display data in a video memory (VRAM) according to a drawing request that is received from the CPU 10 via the bridge device 11. Video data (image data) corresponding to a screen image to be displayed on the LCD 3 is stored in the video memory.

The SSD 16 stores various kinds of parameter information relating to palyback operation. Examples of the parameter information are subtitle size information 160, brightness information 161, sound volume information 162, picture size information 163, and DPI values 164. The subtitle size information 160 includes parameter values representing sizes of subtitles to be displayed together with a video. The brightness information 161 includes parameter values representing brightness levels of the LCD 3. The sound volume information 162 includes parameter values representing volume levels of sounds to be output from the speakers 26. The picture size information 163 includes parameter values representing sizes of windows to be displayed on the LCD 3. Switching to full-screen display, for example, can be made by switching to a large parameter value of the picture size information 163. The DPI values are parameter values each indicating the number of points to express 1-inch information. A narrow part of an image can be displayed, that is, enlarged display can be performed, by switching to a large DPI value.

The video player application program 31 performs video palyback using the above various kinds of parameter information. If the setting of any of the various kinds of parameter information is changed by a user manipulation, the video player application program 31 performs palyback using the specified parameter value. For the various kinds of parameter information, parameter values specified by the user are stored as user setting values. At the time of a first operation or the setting value of a certain kind of parameter information has not been changed by a user manipulation, its user setting value is equal to a parameter value that was set at the time of shipment. How the video player application program 31 performs a video palyback control using the various kinds of parameter information will be described later in detail.

The embedded controller (EC) 18 has a function of powering on or off the electronic apparatus 1 according to a user manipulation on the power switch 6. That is, the embedded controller 18 controls the power circuit 21. The embedded controller 18 includes the touch panel controller 19 for controlling the touch panel 4 which is provided on the LCD 3. The embedded controller 18 is always kept operational irrespective of whether the electronic apparatus 1 is powered on or off.

The embedded controller 18 also includes the docking detector 20 for detecting connection of the connector 2 to the first connector 101 of the docking station 100. The docking detector 20 is connected to a docking detection signal line for detecting docking/undocking of the docking station 100. When the docking station 100 is connected to the electronic apparatus 1, the docking detection signal line is connected to a ground terminal of the docking station 100, whereby the level of a docking detection signal is changed from a high level to a low level because of presence of a pull-up resistor. On the other hand, when the docking station 100 is removed from the electronic apparatus 1, the docking detection signal line is disconnected from the ground terminal of the docking station 100, whereby the level of the docking detection signal is changed from the low level to the high level. The docking detector 20 detects connection/removal of the docking station 100 on the basis of such a potential variation of the docking detection signal.

The touch panel 4, which is of a resistive film type, a capacitance type, or the like, is configured so as to detect a touch area (touch position) on the touch panel 4 (touch screen display).

While being supplied with external power via an AC adapter 22, the power circuit 21 generates system power to be supplied to the individual components of the electronic apparatus 1 using the external power being supplied. While not being supplied with external power via the AC adapter 22, the power circuit 21 generates system power using a battery 23.

The docking station 100 has the first connector 101, the second connector 102, an I/O controller 103, and an EEPROM 104. The first connector 101 is a connector for connection to the electronic apparatus 1, and the second connector 102 is a connector for connection to another electronic apparatus (not shown).

When the first connector 101 is connected to the connector 2 of the electronic apparatus 1, the I/O controller 103 is electrically connected to an I/O controller 24 of the electronic apparatus 1 via a bus signal line. The I/O controller 103 sends and receives various data, control signals, etc. via the bus signal line.

The EEPROM 104 stores identification information of the docking station 100. When the first connector 101 is connected to the connector 2, the I/O controller 103 and the EEPROM 104 are connected to the power circuit 21 of the electronic apparatus 1 and supplied with power from the power circuit 21.

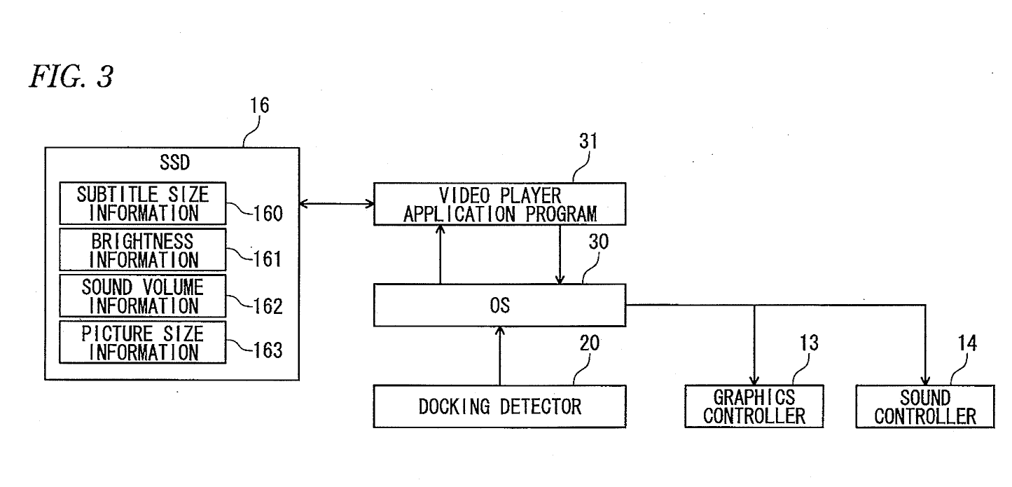

FIG. 3 illustrates a configuration relating to a first video palyback control performed in the electronic apparatus 1 according to the embodiment. The first video palyback control which is performed by the video player application program 31 using the subtitle size information 160, the brightness information 161, the sound volume information 162, and the picture size information 163 (first Example) will be described below. In addition, a second video palyback control which is performed by the OS 30 using the DPI values 164 (second Example) will be described later.

First, the CPU 10 starts palyback of video data by running the video player application program 31. Then, if detecting connection of first connector 101 of the docking station 100 to the connector 2, the docking detector 20 informs the OS 30 that the level of the docking detection signal has changed to the low level. The OS 30 informs the video player application program 31 of that fact. The video player application program 31 changes parameter values used for the current palyback operation to larger parameter values. The user may be allowed to determine whether or not the user is to change each kind of parameter information, or the video player application program 31 may change each kind of parameter information automatically. The video player application program 31 may either change kinds of parameter information selected by the user or change all kinds of parameter information automatically. Where kinds of parameter information to be changed are selected by the user, a control that conforms to user tastes is enabled; for example, a control is possible in which only the sound volume is increased and the image size is not changed.

The video player application program 31 informs the OS 30 of changed parameter values. The OS 30 controls the sound controller 25 and the graphics controller 13 using the received parameter values. With such a control, in a docked state, all of part of the subtitle size, the brightness, the sound volume, and the picture size can be increased.

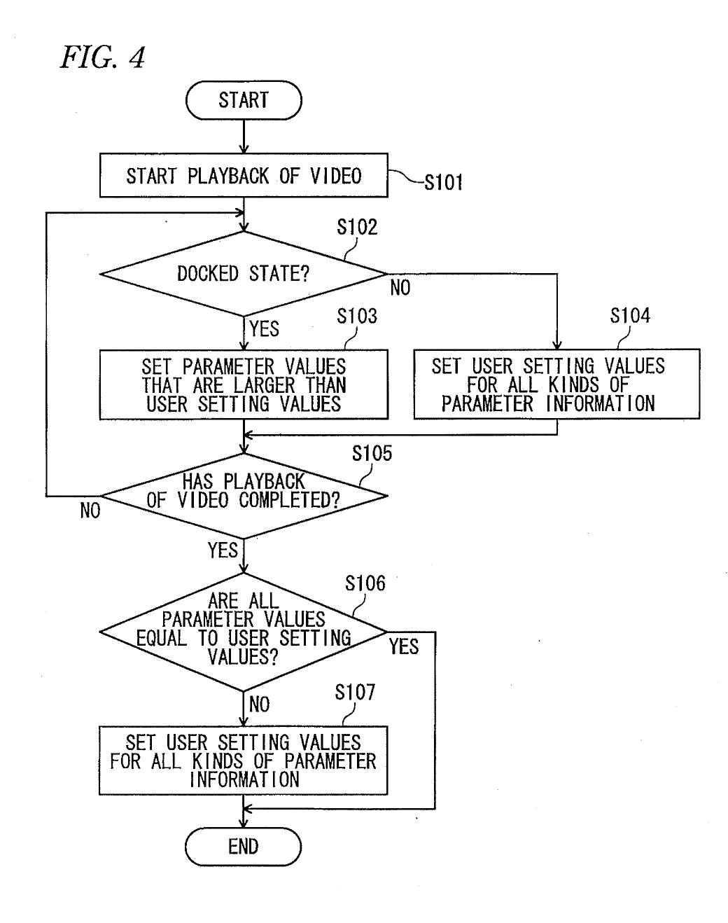

FIG. 4 illustrates a process for the first video palyback control performed in the electronic apparatus 1 according to the embodiment. First, at step S101, the video player application program 31 starts palyback of a video (moving image). At step S102, the docking detector 20 judges whether or not a docked state is established. More specifically, the docking detector 20 detects whether or not the first connector 101 is connected to the connector 2 on the basis of a potential variation of the docking detection signal line. If it is judged that a docked state is established (S102: yes), at step S103 the video player application program 31 sets parameter values that are larger than user setting values. That is, in the docked state, all or part of the subtitle size, the sound volume, the picture size, and the brightness are increased.

On the other hand, if it is judged that a docked state is not established (S102: no), at step S104 the video player application program 31 sets the user setting values for all kinds of parameter information. That is, in the undocked state, the palyback is continued with the various kinds of parameter information unchanged (i.e., kept at the user setting values).

At step S105, the video player application program 31 judges whether or not the palyback of the video has completed. If it is judged that the palyback of the video has not completed yet (S105: no), the process returns to step S 102. On the other hand, if it is judged that the palyback of the video has completed (S105: yes), at step S106 the video player application program 31 judges whether or not all the parameter values are equal to the user setting values. If it is judged that all the parameter values are equal to the user setting values (S106: yes), the process is finished. On the other hand, it is judged that there are parameter values that are not equal to corresponding user setting values (S106: no), at step S107 the video player application program 31 sets the user setting values for all kinds of parameter information. That is, when the palyback of the video has completed, the image display state and the sound volume corresponding to the user setting values are restored. Then, the process is finished.

As described above, in the video palyback control of the first Example, the video player application program 31 changes the various kinds of parameter information according to switching between the docked state and the undocked state. Therefore, when a video is played back in the docked state, all or part of the subtitle size, the brightness, the sound volume, the picture size, etc. are increased. As a result, the user can view the video without any problems even if he or she is distant from the electronic apparatus 1.

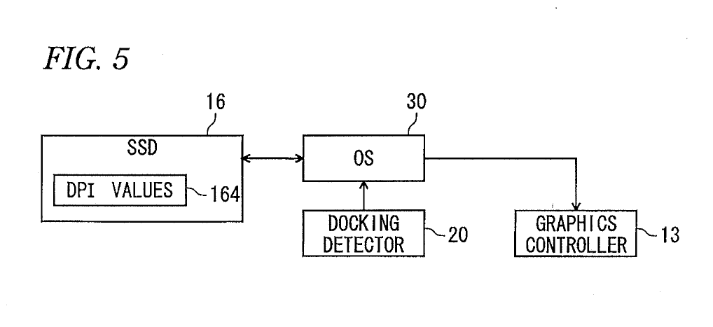

Next, the second Example will be described. FIG. 5 illustrates a configuration relating to a second video palyback control performed in the electronic apparatus 1 according to the embodiment. First, if detecting connection of first connector 101 of the docking station 100 to the connector 2, the docking detector 20 informs the OS 30 that the level of the docking detection signal has changed to the low level.

When receiving that information, the OS 30 switches to a larger DPI value than a value that is being used for the current display. This control enables enlarged display (in the docked state).

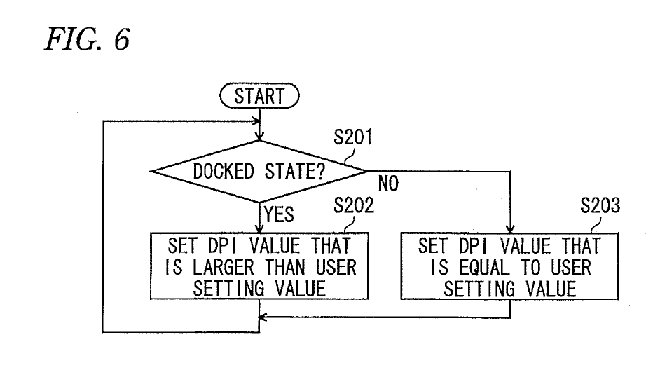

FIG. 6 illustrates a process for the second video palyback control performed in the electronic apparatus 1 according to the embodiment. First, at step S201, the docking detector 20 judges whether or not a docked state is established. More specifically, the docking detector 20 detects whether or not the first connector 101 is connected to the connector 2 on the basis of a potential variation of the docking detection signal line. If it is judged that a docked state is established (S201: yes), at step S202 the OS 30 sets a DPI value 164 that is larger than a user setting value. That is, the image size is increased in the docked state.

On the other hand, if it is judged that a docked state is not established (S201: no), at step 5203 the OS 30 sets a DPI value 164 that is equal to the user setting value. That is, in the undocked state, the palyback is continued with the DPI value unchanged (i.e., kept at the user setting value).

As described above, in the video palyback control of the second Example, the OS 30 changes the DPI value according to switching between the docked state and the undocked state. Therefore, enlarged display is performed in the docked state. As a result, the user can view a displayed image without any problems even if he or she is distant from the electronic apparatus 1.

Although in the above embodiment the image size, the sound value, etc. are increased by changing the various kinds of parameter information and the DPI value, the invention is not limited to such a case. Pieces of processing performed inside the electronic apparatus 1 may be in other forms as long as the image size, the sound value, etc. are made larger or higher in the docked state than in the undocked state.

Although the embodiment has been described above, the embodiment is just an example and should not restrict the scope of the invention. The novel embodiment may be practiced in other various forms, and part of it may be omitted, replaced by other elements, or changed in various manners without departing from the spirit and scope of the invention. These modifications will fall within the scope of Claims and its equivalents.

1. An electronic apparatus, comprising:
a connection module configured to be detachably connected with an external device;
a display configured to display an image; and
a display controller configured to control the display so that a first image is displayed when the connection module is connected to the external device, the first image being larger than a second image that is displayed when the connection module is not connected to the external device.

2. The apparatus of claim 1,
wherein the display controller is configured to control the display so that first characters are displayed when the connection module is connected to the external device, the first characters being larger than second characters that are displayed when the connection module is not connected to the external device.

3. The apparatus of claim 1,
wherein the display controller is configured to control the display so that a first window is displayed when the connection module is connected to the external device, the first window being larger than a second window that is displayed when the connection module is not connected to the external device.

4. The apparatus of claim 1, further comprising:
a brightness controller configured to control brightness of the display,
wherein the brightness controller is configured to set a first brightness of the display, the first brightness being higher when the connection module is connected to the external device than a second brightness that is set when the connection module is not connected to the external device.

5. The apparatus of claim 1, further comprising:
a speaker configured to output a sound; and
a sound volume controller configured to control volume of the sound output from the speaker,
wherein the sound volume controller is configured to set a first volume, the first volume being higher when the connection module is connected to the external device than a second volume that is set when the connection module is not connected to the external device.

6. A control method, comprising:
displaying an image on a display; and
controlling the display so that a first image is displayed, the first image being larger when a connection module that is detachably connectable with an external device is connected to the external device than a second image that is displayed when the connection module is not connected to the external device.
